(19) United States
(12) Patent Application Publication
(10) Pub. No.: US 2004/0005136 A1
(43) Pub. Date: Jan. 8, 2004

(54) Surface protection film for optical film

(75) Inventor: Kazuhito Okumura, Ibaraki-shi (JP)

Correspondence Address: SUGHRUE MION, PLLC, 2100 PENNSYLVANIA AVENUE, N.W., WASHINGTON, DC, 20037, US

(73) Assignee: NITTO DENKO CORPORATION

(21) Appl. No.: 10/608,566

(22) Filed: Jun. 30, 2003

(30) Foreign Application Priority Data
Jul. 8, 2002 (JP) P. 2002-198226

(51) Int. Cl. G02B 6/00

(52) U.S. Cl. 385/147

(57) ABSTRACT

A surface protection film for optical films contains a base material film containing a poly(lactic acid)-based film; an optical film having a surface protection film applied thereto contains, as the surface protection film, the surface protection film described above; and an image display device having a surface protection film applied thereto contains, as the surface protection film, the surface protection film described above.

### FIELD OF THE INVENTION

The present invention relates to a surface protection film for optical films. The surface protection film for optical films of the invention is usable for the surface protection of various optical films including a polarizing film, retardation film, and antireflection film. The surface protection film is usable also for the protection of various image display devices such as, e.g., a liquid-crystal display device, in which the surface protection film is applied to the display surface of a liquid-crystal module having an optical film as the outermost layer, and an organic EL display device and a PDP.

### BACKGROUND OF THE INVENTION

A surface protection film is generally applied to the surface of various optical films such as, e.g., polarizing films, retardation films, and antireflection films for the purposes of marring prevention and fouling prevention. As such a surface protection film has hitherto been employed a surface-protective pressure-sensitive adhesive sheet comprising a flexible plastic film and a re-peelable pressure-sensitive adhesive layer formed on one side thereof over the whole surface.

A liquid-crystal display device is produced by superposing a liquid crystal and various optical films such as, e.g., a polarizing film, retardation film, and antireflection film on a glass substrate, fixing the periphery of the resultant structure with a fixing frame constituted of a metallic plate made of, e.g., stainless steel, which is called “bezel”, to give a liquid-crystal module, assembling the module and other components, and housing the assembly in a case. The display surface of such liquid-crystal display devices, which have an optical film as the outermost layer, is generally covered with a surface protection film in order to prevent the adhesion of or fouling by dust particles or the like during assembly steps or merchandise distribution. Namely, the display surface is covered with the surface protection film in the steps of liquid-crystal module production. Techniques which have been employed for this display surface protection include a method in which a surface-protective pressure-sensitive adhesive sheet comprising a flexible plastic film and a re-peelable pressure-sensitive adhesive layer formed on one side thereof over the whole surface is applied as the surface protection film to the display surface of the liquid-crystal module. In another technique, the display surface is covered with a plastic film (having no pressure-sensitive adhesive layer) and the film is then fixed with a pressure-sensitive adhesive tape.

The surface protection film applied to an optical film, e.g., polarizing film, is in an evenly adherent state at the time when the polarizing film or the like is shipped. Usually, this surface protection film is used also in the steps of liquid-crystal module production for the prevention of surface marring/fouling. However, in the steps of liquid-crystal module production, the surface protection film is repeatedly peeled/applied and the surface protection film reapplied is usually in a blistered or creased state. There have been cases where when the surface protection film in such a state is finally peeled off, unevenness in brightness is observed on the display surface (the display surface has a difference in brightness between the areas which were in contact with the surface protection film and the areas which were not in contact therewith). This brightness unevenness may impair the reliability of the liquid-crystal display device.

Furthermore, there have also been cases where when a liquid-crystal display device fabricated from a liquid-crystal module whose display surface was covered with a surface protection film is actually used (i.e., when the liquid-crystal display device from which the surface protection film has been peeled after distribution is used), then brightness unevenness is observed on the display surface.

### SUMMARY OF THE INVENTION

An object of the invention is to provide a surface protection film for optical films which does not cause unevenness in image brightness even when it is applied to various optical films, e.g., polarizing films, and these optical films covered with the surface protection film are processed and stored.

Another object of the invention is to provide a surface protection film-covered optical film and a surface protection film-covered image display device which each has the surface protection film applied thereto.

Still another object of the invention is to provide a method of protecting a surface of an optical film with the surface protection film and a method of protecting a display surface of an image display device with the surface protection film.

The present inventors made intensive investigations in order to eliminate the problems described above. As a result, they have found that those objects can be accomplished with the surface protection film for optical films described below. The invention has thus been achieved.

The invention relates to a surface protection film for optical films which comprises a base material film comprising a poly(lactic acid)-based film.

The surface protection film for optical films may have a pressure-sensitive adhesive layer disposed on one side of the base material film.

The invention further relates to an optical film having a surface protection film applied thereto, wherein the surface protection film is the surface protection film described above. The invention still further relates to an image display device having a surface protection film applied thereto, wherein the surface protection film is the surface protection film described above.

The invention furthermore relates to a method of protecting a surface of an optical film which comprises covering the surface of the optical film with the surface protection film described above. The invention furthermore relates to a method of protecting a display surface of an image display device which comprises covering the display surface of the image display device with the surface protection film described above.

The surface protection film for optical films of the invention comprises a poly(lactic acid)-based film as a base material film. Because of this, even when various optical films having this surface protection film adherent thereto are processed and stored and the surface protection film is peeled off thereafter, then the optical films have no change in optical color tone (brightness unevenness). As a result, an image display device free from brightness unevenness and having high reliability can be provided.

Besides being useful in the surface protection of individual optical films having various functions, such as, e.g., a polarizing film, retardation film, and antireflection film, the surface protection film for optical films (hereinafter often referred to simply as “surface protection film”) of the invention is applicable to other uses. For example, the surface protection film is usable for the protection of the display surface of a liquid-crystal module comprising these optical films as constituent materials, and for the protection of the display surface of various image display devices such as a liquid-crystal display device (finished product) obtained by fitting the liquid-crystal module into a case or the like together with other components. The surface protection film for optical films of the invention is usable also in the form of a tape.

### BRIEF DESCRIPTION OF THE DRAWINGS

FIG. 1 is a diagrammatic view illustrating the evaluation of a polarizing film for brightness unevenness after surface protection film peeling therefrom.

### DESCRIPTION OF REFERENCE NUMERALS

1 surface protection film

10 polarizing film

### DETAILED DESCRIPTION OF THE INVENTION

The surface protection film for optical films of the invention comprises a base material film comprising a poly(lactic acid)-based film. This poly(lactic acid)-based film comprises one or more lactic acid polymers as the main component. Examples of the lactic acid polymers include poly(lactic acid)s and copolymers of a lactic acid with one or more other hydroxycarboxylic acids. Such lactic acid polymers may be used alone or as a mixture of two or more thereof.

Examples of the lactic acid include L-lactic acid and D-lactic acid. Of these, L-lactic acid is preferred. Examples of other hydroxycarboxylic acids include glycolic acid, 3-hydroxybutyric acid, 4-hydroxybutyric acid, 3-hydroxyvaleric acid, 4-hydroxyvaleric acid, and 6-hydroxycaproic acid. The lactic acid polymer constituting the base material film in the invention most preferably is a poly(lactic acid) made up of monomer units derived only from one or more lactic acids.

Polymerization methods for producing the lactic acid polymer are not particularly limited. For example, any of known processes such as condensation polymerization and ring-opening polymerization may be employed. The weight-average molecular weight of the lactic acid polymer is preferably about from 10,000 to 1,000,000. The lactic acid polymer may be one obtained using a small amount of a chain extender or crosslinking agent such as, e.g., a polyisocyanate compound, polyepoxy compound, or acid anhydride in order to further increase the molecular weight.

Although the poly(lactic acid)-based film comprises the lactic acid polymer as the main component, it may contain other polymeric materials as long as the effects of the invention are not lessened thereby. Examples of the optional polymeric materials include polyesters other than poly(lactic acid)s, polyolefins, polystyrene, poly (meth) acrylonitrile, cellulosic materials, poly (vinyl alcohol), polyamides, poly(vinyl acetate), and poly(phenylene oxide). It is, however, preferred to avoid incorporation of an aliphatic polyester into the lactic acid polymer. In case where an aliphatic polyester is incorporated, the poly(lactic acid)-based film is apt to blush when stored under high-temperature high-humidity conditions. The incorporation of an aliphatic polyester is hence undesirable in this application.

Additives such as, e.g., a plasticizer, lubricant, inorganic filler, ultraviolet absorber, and antistatic agent may be added to the poly(lactic acid)-based film for the purpose of regulating moldability and film properties.

Processes for producing the poly(lactic acid)-based film are not particularly limited. For example, the film can be produced by forming either the lactic acid polymer or a composition comprising the polymer as the main component into a film by the melt extrusion method. The poly(lactic acid)-based film may be stretched uniaxially or biaxially by rolling, tentering, etc. Such a stretched film is preferred because of its excellent strength. A biaxially stretched film is especially preferred. Although the stretch ratio is not particularly limited, it is preferably up to 5, more preferably from 1.5 to 5.

The thickness of the poly(lactic acid)-based film as the base material film is generally 10 μm or larger, preferably 15 μm or larger, more preferably from 20 to 200 μm, from the standpoint of workability (handleability of the surface protection film).

The surface protection film of the invention may consist only of the base material film comprising a poly(lactic acid)-based film, or may have a pressure-sensitive adhesive layer disposed on one side of the poly(lactic acid)-based film.

The pressure-sensitive adhesive to be used for constituting the pressure-sensitive adhesive layer may be suitably selected from pressure-sensitive adhesives for use in surface protection films. For example, use can be made of pressure-sensitive adhesives of the acrylic, polyester, urethane, polyether, and rubber-based types. In general, an acrylic pressure-sensitive adhesive is advantageously used because it is excellent in transparency, processability, durability, etc. In order to obtain a pressure-sensitive adhesive layer having a desired adhesive force, the pressure-sensitive adhesive is applied by the common coating method such as roll coater method, die coater method, bar coater method and the like, in an amount of generally about from 1 to 50 g, preferably from 3 to 30 g, on a dry basis per m² of the film. The thickness of the pressure-sensitive adhesive layer is preferably from 0.5 to 50 μm, more preferably from 2 to 30 μm.

The base material film or the pressure-sensitive adhesive layer in the surface protection film of the invention may be subjected to an antistatic treatment, or a backside treatment layer may be formed on the surface protection film. In the case where a pressure-sensitive adhesive layer is formed on the base material film, the backside treatment layer is formed on the side opposite to the pressure-sensitive adhesive layer.

The antistatic treatment is usually accomplished, for example, by incorporating an antistatic agent into the base material film and/or the pressure-sensitive adhesive layer through kneading or by forming a priming layer (antistatic layer) on the base material film before the formation of a pressure-sensitive adhesive layer and/or backside treatment layer. For the antistatic treatment, known antistatic agents for use in polymeric materials can be used. The following ones are especially preferable.

Examples of the antistatic agents include various surfactants such as cationic surfactants (e.g., the quaternary ammonium salt type, phosphonium salt type, and sulfonium salt type), anionic surfactants (e.g., the carboxylic acid type, sulfonate type, sulfate type, phosphate type, and phosphite type), amphoteric surfactants (e.g., the sulfobetaine type, alkylbetaine type, and alkylimidazolinium betaine type), and nonionic surfactants (e.g., polyhydric alcohol derivatives, β-cyclodextrin clathrate compounds, sorbitan fatty acid monoesters and diesters, poly(alkylene oxide) derivatives, and amine oxides). Such antistatic agents are incorporated into a base material film and/or a pressure-sensitive adhesive layer through kneading or used for forming an antistatic layer.

Examples thereof further include polymers having ionic conductivity, such as a homopolymer of a monomer having an ion-conductive group, e.g., a cationic monomer (e.g., quaternary ammonium salt), amphoteric monomer (e.g., betaine compound), anionic monomer (e.g., sulfonic acid salt), or nonionic monomer (e.g., glycerol), a copolymer of the monomer with other monomer(s), and a polymer having units derived from an acrylate or methacrylate having a quaternary ammonium salt group. These antistatic agents are used for forming an antistatic layer.

Examples of the antistatic agents further include antistatic coating materials containing a polymer such as a polyester, urethane, acrylic, or acrylic-melamine as a binder. These antistatic agents are used for forming an antistatic layer.

Examples thereof furthermore include permanent antistatic agents of the type obtained by alloying a hydrophilic polymer, e.g., an ethylene/methacrylate copolymer, with an acrylic resin or the like. These antistatic agents are incorporated into a base material film and/or a pressure-sensitive adhesive layer through kneading.

Examples of the antistatic agents furthermore include conductive fillers such as acetylene black, Ketjen Black, natural graphite, artificial graphite, titanium black, zinc oxide, tin oxide, tin-coated titanium oxide, nickel flakes, phosphorus-doped tin oxide, and antimony-doped tin oxide. These antistatic agents are incorporated into a base material film and/or a pressure-sensitive adhesive layer through kneading.

The antistatic coating materials described above generally contain a conductive filler. The conductive fillers to be used in these coating materials are basically the same as the aforementioned conductive fillers for incorporation into a base material film and/or pressure-sensitive adhesive layer through kneading. Namely, acetylene black, Ketjen Black, natural graphite, artificial graphite, and titanium black are used as conductive fillers for black antistatic coating materials. Zinc oxide, tin oxide, and tin-coated titanium oxide are used as conductive fillers for white antistatic coating materials. Nickel flakes are used as a conductive filler for silver antistatic coating materials. Phosphorus-doped tin oxide and antimony-doped tin oxide are used as conductive fillers for clear antistatic coating materials.

The amount of the antistatic agent to be used is generally small regardless of the mode of use in which the antistatic agent is used for forming an antistatic layer, incorporated into a base material film through kneading, or incorporated into a pressure-sensitive adhesive layer through kneading. In the case where an antistatic layer is formed, the amount of the antistatic agent to be applied (deposition amount after drying) per m² of the film is generally about from 0.01 to 5 g, preferably about from 0.05 to 2 g. When the antistatic agent is incorporated into a base material film through kneading, it is used in an amount of generally about from 0.1 to 5% by weight, preferably about from 0.2 to 2% by weight, based on the base material film. When the antistatic agent is incorporated into a pressure-sensitive adhesive layer through kneading, it is used in an amount of generally about from 0.1 to 5% by weight, preferably about from 0.2 to 2% by weight, based on the pressure-sensitive adhesive.

The backside treatment agent (release agent) to be used for forming the backside treatment layer can be any of known materials used as backside treatment agents (release agents) in the field of pressure-sensitive adhesive tapes and the like. Preferred of these are alkyl pendant type release agents and silicone release agents. Especially preferred are alkyl pendant type release agents. Preferred examples of the alkyl pendant type release agents include ones consisting mainly of a copolymer of a long-chain alkyl acrylate, copolymer of a perfluoroalkyl acrylate, copolymer of a (long-chain alkyl)acrylamide, copolymer of a long-chain alkyl derivative of maleic acid, long-chain alkyl ester of a hydroxyl-containing polymer, (long-chain alkyl)carbamate of a hydroxyl-containing polymer, perfluoroalkylcarbamate of a hydroxyl-containing polymer, or the like. In these polymers, each long-chain alkyl preferably has 18 to 30 carbon atoms. The silicone release agents can be either condensation type silicones or addition type silicones. The amount of the backside treatment agent (release agent) to be applied per m² of the base material film is generally about from 0.005 to 2 g, preferably from 0.01 to 1 g.

The invention will be explained below in greater detail by reference to Examples and Comparative Examples, but the invention should not be construed as being limited by these Examples.

### EXAMPLE 1

A biaxially stretched poly(lactic acid) film (Ecoloju SEP, manufactured by Mitsubishi Plastics Industries Ltd.; 100% lactic acid polymer; thickness, 25 μm) was used as a base material film. This film was used as a surface protection film.

### EXAMPLE 2

One side of the base material film described in Example 1 was subjected to a corona treatment. Thereafter, a backside treatment agent was applied to the untreated side of the film with a #9 wire-wound bar, and the coating was dried at 80° C. for 1 minute to form a backside treatment layer. As the backside treatment agent was used a solution prepared by dissolving an alkylcarbamate type release agent (Peel Oil 1010, manufactured by Ipposha Oil Industries Co., Ltd.) in toluene in a solid content of 0.3% by weight.

Subsequently, an antistatic agent was applied to the corona-treated side of the film with a #6 wire-wound bar, and the coating was dried at 80° C. for 1 minute to form a priming layer. As the antistatic agent was used one containing an ionically conductive polymer (BONDEIP, manufactured by Konishi Co., Ltd.) (i.e., one comprising 1 g of BONDEIP PX Main Ingredient (solid content, about 32%), 1 g of BONDEIP PX Hardener (solid content, about 8%), 12 g of isopropyl alcohol, and 6 g of water).

The priming layer was then coated with a pressure-sensitive adhesive solution with an applicator, and the coating was dried at 80° C. for 2 minutes to form a pressure-sensitive adhesive layer having a thickness of 5 μm on a dry basis. Thus, a surface protection film was obtained. As the pressure-sensitive adhesive solution was used one containing 100 parts by weight of an acrylic polymer (butyl acrylate/2-ethylhexyl acrylate/acrylonitrile/acrylic acid=85/10/2/3 (by weight) copolymer; weight-average molecular weight, 600,000; ordinary solution polymerization) and 3 parts by weight of an epoxy crosslinking agent (Tetrad C, manufactured by Mitsubishi Gas Chemical Company, Inc.).

### COMPARATIVE EXAMPLE 1

A biaxially stretched poly(ethylene terephthalate) film (Lumirror S10, manufactured by Toray Industries, Inc.; thickness, 25 μm) was used as a base material film. This film was used as a surface protection film.

### COMPARATIVE EXAMPLE 2

A backside treatment layer, priming layer, and pressure-sensitive adhesive layer were formed to obtain a surface protection film in the same manner as in Example 2, except that the base material film used in Comparative Example 1 was used.

### COMPARATIVE EXAMPLE 3

A polyolefin film (film formed by inflation from Sumikathene 12, manufactured by Sumitomo Mitsui Polyolefin Co., Ltd.; thickness 60 μm) was used as a base material film. This film was used as a surface protection film.

### COMPARATIVE EXAMPLE 4

A backside treatment layer, priming layer, and pressure-sensitive adhesive layer were formed to obtain a surface protection film in the same manner as in Example 2, except that the base material film used in Comparative Example 3 was used.

The surface protection films obtained in the Examples and Comparative Examples were subjected to the following evaluations. The results obtained are shown in Table 1.

1. Evaluation of Brightness Unevenness

(Test Method)

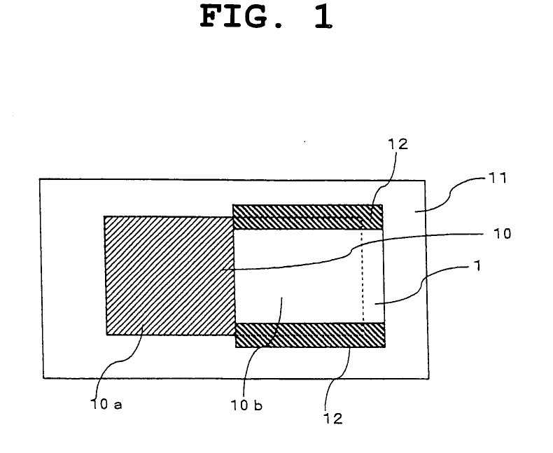

As shown in FIG. 1, a polarizing film 10 (NWF-SEG1425WVARC150K) manufactured by Nitto Denko Corp. on which a pressure-sensitive adhesive layer had been formed was applied to a glass plate 11. Subsequently, a surface protection film 1 was placed on about a half of the polarizing film 10 (in Example 2 and Comparative Examples 2 and 4, the film 1 was placed so that the pressure-sensitive adhesive layer faced the polarizing film). Edges of the surface protection film 1 were fixed with tapes 12 (No. 31B) manufactured by Nitto Denko Corp. The sample thus produced was placed in a 40° C. thermo-hygrostatic chamber, stored therein for 10 hours, and then taken out.

(Evaluation Method)

The fixing tapes 12 and the surface protection film 1 were peeled off. Subsequently, in a dark room, the glass plate 10 was illuminated from under it, and another polarizing film (NPF HEG1425DU, manufactured by Nitto Denko Corp.) was used to establish a crossed nicol state. The polarizing films superposed were visually examined from right above and from various angles. The polarizing films which had no brightness difference between the area 10a to which the surface protection film 1 had not been adherent (free part) and the area 10b to which the surface protection film 1 had been adherent were rated as “◯”, while the polarizing films which had a brightness difference therebetween were rated as “X”.

2. Appearance Evaluation after Heating and Humidifying

Each surface protection film was allowed to stand for 7 days in a thermo-hygrostatic chamber having a temperature of 60° C. and a relative humidity of 90% RH, subsequently returned to room temperature, and then examined for appearance. The surface protection films having no abnormality were rated as “◯”, while those having abnormality were rated as “X”.

TABLE 1

| | | Presence or | | |
|---|---|---|---|---|
| | | absence of | | |
| | Material of | pressure- | | |
| | base | sensitive | | |
| | material | adhesive | Brightness | |
| | film | layer, etc. | unevenness | Appearance |
| Example 1 | poly (lactic | absent | ◯ | ◯ |
| | acid) | | | |
| Example 2 | poly (lactic | present | ◯ | ◯ |
| | acid) | | | |
| Comparative | polyester | absent | X | ◯ |
| Example 1 | | | | |
| Comparative | polyester | present | X | ◯ |
| Example 2 | | | | |
| Comparative | polyolefin | absent | X | ◯ |
| Example 3 | | | | |
| Comparative | polyolefin | present | X | ◯ |
| Example 4 | | | | |

While the invention has been described in detail and with reference to specific embodiments thereof, it will be apparent to one skilled in the art that various changes and modifications can be made therein without departing from the spirit and scope thereof.

What is claimed is:

1. A surface protection film for optical films which comprises a base material film comprising a poly(lactic acid)-based film.

2. The surface protection film for optical films of claim 1, which comprises a pressure-sensitive adhesive layer disposed on one side of the base material film.

3. An optical film having a surface protection film applied thereto, wherein the surface protection film is the surface protection film of claim 1.

4. An optical film having a surface protection film applied thereto, wherein the surface protection film is the surface protection film of claim 2.

5. An image display device having a surface protection film applied thereto, wherein the surface protection film is the surface protection film of claim 1.

6. An image display device having a surface protection film applied thereto, wherein the surface protection film is the surface protection film of claim 2.

7. A method of protecting a surface of an optical film which comprises covering the surface of the optical film with the surface protection film of claim 1.

8. A method of protecting a surface of an optical film which comprises covering the surface of the optical film with the surface protection film of claim 2.

9. A method of protecting a display surface of an image display device which comprises covering the display surface of the image display device with the surface protection film of claim 1.

10. A method of protecting a display surface of an image display device which comprises covering the display surface of the image display device with the surface protection film of claim 2.
